(19) United States
(12) Patent Application Publication
(10) Pub. No.: US 2001/0026330 A1
(43) Pub. Date: Oct. 4, 2001

(54) Liquid crystal display employing touch panel

(76) Inventor: Hyeok-jin Oh, Kyungsangnam-do (KR)

Correspondence Address: LEYDIG VOIT & MAYER, LTD, 700 THIRTEENTH ST. NW, SUITE 300, WASHINGTON, DC, 20005-3960, US

(21) Appl. No.: 09/791,730

(22) Filed: Feb. 26, 2001

(30) Foreign Application Priority Data
Mar. 28, 2000 (KR) 200-15865

(51) Int. Cl. G02F 1/1335

(52) U.S. Cl. 349/12

(57) ABSTRACT

A liquid crystal display including a display panel having a plurality of substrate having electrodes formed thereon, alignment layers formed on the electrodes and firs liquid crystal filled between the substrates, a touch panel installed on the display panel, and having a plurality of substrates having aligned conductive layers, electrodes electrically connected with the conductive layers, a dot spacer disposed between the substrates, for maintaining the gap therebetween, and second liquid crystal filled between the substrates, for compensating for a phase difference of the display panel, and polarizing plates formed on the outer surfaces of the display panel and the touch panel. Since a compensating function is added to the touch panel integrally formed with the liquid crystal display, the thickness and weight of the display are greatly reduced.

### BACKGROUND OF THE INVENTION

1. Field of the Invention

The present invention relates to a liquid crystal display, and more particularly, to a liquid crystal display employing a touch panel having an improved connection structure between an input device such as the touch panel and a liquid crystal display.

2. Description of the Related Art

In general, a liquid crystal display displays figures and/or characters by generating light and shade such that liquid crystals are injected between two thin glass substrates and power is supplied to cause a change in the arrangement of liquid crystal molecules.

Generally, a super twisted nematic (STN) liquid crystal display in which a twisted angle ranges from 180° to 270° is advantageous for large-scale display and has a wider angle of view, than a twisted nematic (TN) liquid crystal display. The STN liquid crystal display cannot achieve black-and-white image display in which a twisted angle is 90°. To solve this problem, various improved types of liquid crystal displays are being proposed.

In particular, there has been proposed a double STN (DSTN) liquid crystal display which can implement both color and monochrome image display by additionally installing a compensation panel to form double STN cells. DSTN liquid crystal displays are widely used for gauge boards of automobiles.

A liquid crystal display has an input device such as a touch panel or a digitizer integrally formed thereon, and utilizes information by touching the same by a finger or pen.

FIG. 1 shows a liquid crystal display (LCD) 10 employing a conventional touch panel 100.

Referring to the drawing, the LCD 10 is a DSTN type LCD.

The LCD 10 is largely divided into two cells; one is a display panel 11 and the other is a compensation panel 12.

A front substrate 13 and a rear substrate 14 are opposite to each other and are installed on the display panel 11. Although not shown, transparent, intersecting front and rear electrodes, polyimide layers aligned on the electrodes, liquid crystals interposed therebetween, and a spacer disposed to control the cell distance between the substrates 13 and 14, are provided between the substrates 13 and 14. Sealing members 15 for fixedly adhering the substrates 13 and 14 are disposed at edges of the substrates 13 and 14 for the purpose of preventing penetration of external moisture into the panel 11.

Also, a front substrate 16 and a rear substrate 17 are opposite to each other and are installed on the compensation panel 12. Like in the display panel 11, front and rear electrodes, polyimide layers aligned on the electrodes, liquid crystals interposed therebetween, and a spacer disposed to control the cell distance, are provided between the front and rear substrates 16 and 17. Also, sealing members 18 are formed at edges of the substrates 16 and 17.

As is known well, the twisted direction of the liquid crystals of the compensation panel 12 is opposite to that of the liquid crystals of the display panel 11, for achieving black-and-white display of the LCD 10. Accordingly, the birefringence and view angle of a liquid crystal cell can be compensated for and high transmittance and contrast can be attained.

A rear polarizing plate 19a is installed on the outer surface of the rear substrate 14 of the display panel 11, and a front polarizing plate 19b is fixed to the outer surface of the front substrate 16 of the compensation panel 12.

An input device such as the touch panel 100 is installed on the front polarizing plate 19b.

The touch panel 100 includes an upper substrate 120 having an upper electrode 110, a lower substrate 140 opposite to the upper substrate 120 and having a lower electrode electrode 130 patterned thereon, and a dot spacer 150 for maintaining the gap between the upper and lower substrates 120 and 140. The upper and lower substrates 120 and 140 are adhered to each other by an adhesive tape 160.

Since the aforementioned LCD 10 having the conventional touch panel 100 has dual cells for compensating for each other to have the compensation panel 12 as well as the display panel 11, and also has the touch panel 100 fixed thereon, the thickness and weight thereof increase. Thus, it is difficult to attain thin, lightweight, small LCD 10. Also, the thickness of a cell must be accurately controlled due to strict compensating conditions of the cell.

### SUMMARY OF THE INVENTION

To solve the above problem, it is an objective of the present invention to provide a liquid crystal display employing an improved touch panel further equipped with a function as a compensation cell interposed for compensating for a phase difference, without a necessity of separately providing an additional compensation cell.

Accordingly, to achieve the above objective, there is provided a liquid crystal display including a display panel having a plurality of substrate having electrodes formed thereon, alignment layers formed on the electrodes and firs liquid crystal filled between the substrates, a touch panel installed on the display panel, and having a plurality of substrates having aligned conductive layers, electrodes electrically connected with the conductive layers, a dot spacer disposed between the substrates, for maintaining the gap therebetween, and second liquid crystal filled between the substrates, for compensating for a phase difference of the display panel, and polarizing plates formed on the outer surfaces of the display panel and the touch panel.

The liquid crystals are preferably of a super twisted nematic type in which the twisted angles thereof are in the range of 180° to 270.

Also, the optical retardation of the second liquid crystal is the same as that of the first liquid crystal.

Further, the twisted direction of the second liquid crystal is opposite to that of the first liquid crystal, and the rubbing direction of the second liquid crystal is perpendicular to that of the first liquid crystal.

Also, the conductive layers are preferably formed by coating conductive resist so as to have orientation.

Further, the conductive layers are formed of a material having an alignment property.

### BRIEF DESCRIPTION OF THE DRAWINGS

The above objectives and advantages of the present invention will become more apparent by describing in detail a preferred embodiment thereof with reference to the attached drawings in which:

FIG. 1 is a cross-sectional view schematically showing a liquid crystal display employing a conventional touch panel; and

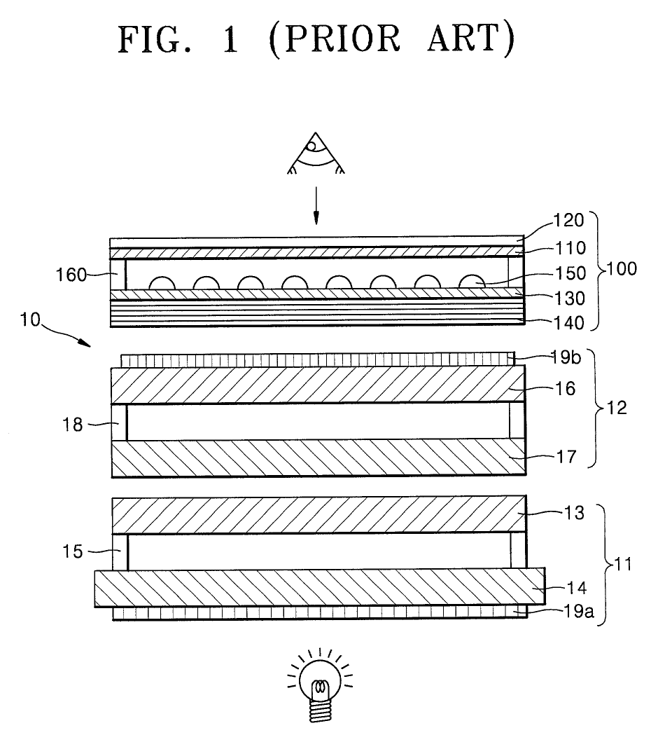

FIG. 2 is a cross-sectional view schematically showing a liquid crystal display employing a touch panel according to the present invention.

### DESCRIPTION OF THE PREFERRED EMBODIMENT

A liquid crystal display employing a conventional touch panel will now be described in detail with reference to the accompanying drawing.

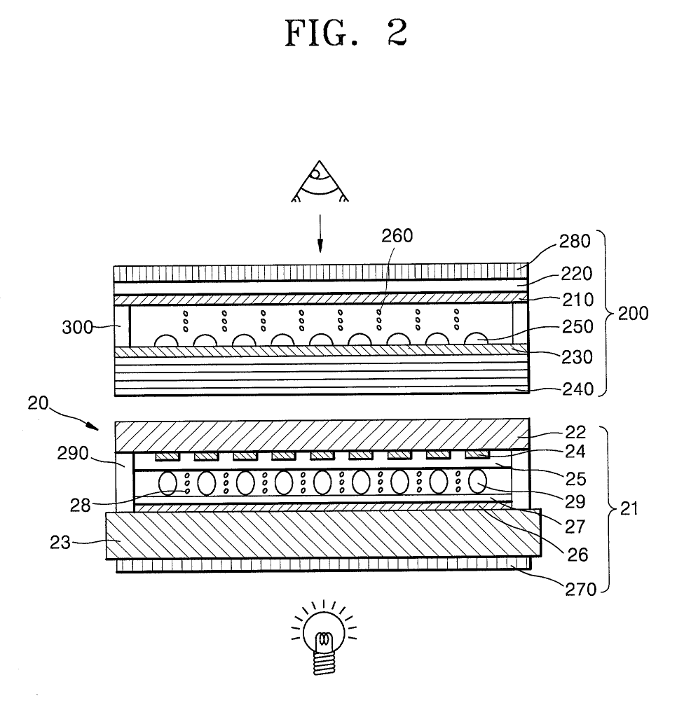

FIG. 2 shows a liquid crystal display (LCD) 20 having a touch panel 200 according to the present invention.

Referring to the drawing, the LCD 20 includes a display panel 21.

A front substrate 22 and a rear substrate 23, made of transparent material, e.g., soda lime glass, are opposite to each other and are installed on the display panel 21.

A front electrode 24 made of a transparent conductive layer is formed on the front substrate 22 in a strip type. A front alignment layer 25 oriented in a predetermined direction is formed on the front electrode 24. A rear electrode 26 made of a transparent conductive layer is formed on the rear substrate 23 in a strip type. A rear alignment layer 27 is formed on the rear electrode 26.

Liquid crystal 28 is filled between the front and rear alignment layers 25 and 27. Here, the twisted angle of the liquid crystal 28 is in the range of 180 to 270°. A spacer 29 is disposed to uniformly maintain the layer thickness of the liquid crystal 28 by controlling the cell distance between the opposed substrates 22 and 23.

Sealing members 290 for preventing penetration of external moisture are disposed at edges of the front and rear substrates 22 and 23 since the liquid crystal 28 exposed to the air is deteriorated due to absorption of moisture, resulting in reduction of specific resistivity or generation of impurity.

According to the feature of the present invention, a touch panel 200 for compensating for a phase difference of the display panel 21 is installed on the display panel 21.

In other words, the touch panel 200 functions as an input device as well as a compensation panel for compensating for a phase difference for black-and-white image display, which cannot be achieved by the display panel 21, which will now be described in more detail.

An upper substrate 220 and a lower substrate 240 which are opposite to each other, are installed on the touch panel 200.

Since the upper substrate 220 is brought into direct contact with an input means such as a finger or pen, it is formed of a flexible film, for example, polymer resin such as PET. An upper conductive layer 210 is formed beneath the upper substrate 220. A plurality of strip-typed upper electrodes (not shown) electrically connected with the upper conductive layer 210 are formed on the upper substrate 220 along the edges of the substrate 220.

The lower substrate 240 is made of transparent glass. A patterned lower conductive layer 230 is coated on the top surface of the lower substrate 240. A plurality of strip-typed lower electrodes (not show) are formed on the top surface of the lower conductive layer 230 along the edges of the lower substrate 240 in a direction different from the installation direction of the upper electrodes. The upper and lower electrodes aggregate at the central portion of one side of the lower substrate 240 to then be installed such that power is applied thereto, and are preferably formed of Ag paste.

An adhesive tape 300 is adhered at both edges between the upper and lower substrates 220 and 240 for adhesion between the substrates 220 and 240 and for isolation of the respective electrodes. Also, a dot spacer 250 is installed on the lower substrate 240. The dot spacer 250 maintains an appropriate distance between the upper and lower substrates 220 and 240. The height of the dot spacer 250 is approximately 4 to 5 μm.

Here, liquid crystal 260 is injected between the upper substrate 220 and the lower substrate 240. The liquid crystal 260 is the same as the liquid crystal 28 of the display panel 21 in twisted angle and is opposite thereto in twisted direction. Also, the rubbing directions of the liquid crystals 28 and 260 are perpendicular to each other.

To this end, the upper conductive layer 210 and the lower conductive layer 230 have conductivity and orientation, and are formed of a material which is capable of aligning the liquid crystal 260. In other words, the upper and lower conductive layers 210 and 230 are preferably formed by coating conductive resist on a transparent conductive layer, aligning and then curing the same. Accordingly, the liquid crystal 260 can be aligned in a predetermined direction. Also, the upper and lower conductive layers 210 and 230 may be formed of a material having an alignment property.

A rear polarizing plate 270 is fixed to the outer surface of the rear substrate 23 of the display panel 21. Also, a front polarizing plate 280 is installed on the outer surface of the upper substrate 220 of the touch panel 200 which functions as an input device and a compensation panel.

The operation of the aforementioned liquid crystal display will now be described.

Nature light generated from a light source such as back light installed in the lower portion of the display panel 21 becomes linear polarized light through the rear polarizing plate 270. The linear polarized light becomes elliptic polarized light by birefringence of the layer of the liquid crystal 28 while passing through the display panel 21.

Here, since the touch panel 200 has the same optical retardation, that is, the product of birefringence ratio (Δn) and cell thickness (d), with the display panel 21, the liquid crystal 260 is aligned such that the twisted direction thereof is opposite to and the rubbing direction thereof is perpendicular to, those of the touch panel 200, thereby functioning as a compensation panel for optical compensation.

Accordingly, the elliptic polarized light of each wavelength having passed through the display panel 21 is restored into linear polarized light having the same azimuth angle by the optical compensation of the compensating cell contained in the touch panel 200. The quantity of light transmitted when a drive voltage is not applied is substantially zero. In such a manner, the optical retardation of each cell in the display panel 21 and the touch panel 200 is set such that the transmittances at R, G, B wavelengths are equal, thereby implementing black-and-white image display.

The touch panel 200 installed on the display panel 21 functions as an input device. When the upper conductive layer 210 formed on the upper substrate 220 and the lower conductive layer 230 formed on the lower substrate 240, with the dot spacer 250 disposed therebetween, contact each other, the upper and lower electrodes are electrically connected with each other. Then, a main controller converts a voltage value changed by the resistance value of the contact position into a digital value to locate position coordinates.

An image can be implemented by adjusting brightness and shade of a compensating cell added to the display panel 21 and the touch panel 200. Also, a user can easily use the liquid crystal display by contacting the upper substrate 220 of the touch panel 200 by means of an input means such as a finger or pen.

As described above, the liquid crystal display employing a touch panel according to the present invention can eliminate a compensation panel from a conventional liquid crystal display having a display panel and a compensation panel for compensating a phase difference of the display panel. Instead, a compensating function is added to the touch panel integrally formed with the liquid crystal display, thereby greatly reducing the thickness and weight of the display. Accordingly, the present invention is advantageous for attainment of small, lightweight, thin displays.

Although the invention has been described with respect to a preferred embodiment, it is not to be so limited as changes and modifications can be made which are within the full intended scope of the invention as defined by the appended claims.

What is claimed is:

1. A liquid crystal display comprising:
a display panel having a plurality of substrate having electrodes formed thereon, alignment layers formed on the electrodes and firs liquid crystal filled between the substrates;
a touch panel installed on the display panel, and having a plurality of substrates having aligned conductive layers, electrodes electrically connected with the conductive layers, a dot spacer disposed between the substrates, for maintaining the gap therebetween, and second liquid crystal filled between the substrates, for compensating for a phase difference of the display panel; and
polarizing plates formed on the outer surfaces of the display panel and the touch panel.

2. The liquid crystal display according to claim 1, wherein the liquid crystals are of a super twisted nematic type in which the twisted angles thereof are in the range of 180° to 270.

3. The liquid crystal display according to claim 1, wherein the optical retardation of the second liquid crystal is the same as that of the first liquid crystal.

4. The liquid crystal display according to claim 3, wherein the twisted direction of the second liquid crystal is opposite to that of the first liquid crystal.

5. The liquid crystal display according to claim 3, wherein the rubbing direction of the second liquid crystal is perpendicular to that of the first liquid crystal.

6. The liquid crystal display according to claim 1, wherein the conductive layers are formed by coating conductive resist so as to have orientation.

7. The liquid crystal display according to claim 1, wherein the conductive layers are formed of a material having an alignment property.
